(19) United States
(12) Patent Application Publication
(10) Pub. No.: US 2008/0043250 A1
(43) Pub. Date: Feb. 21, 2008

(54) Method and apparatus for measuring drawing position, and method and apparatus for drawing image

(75) Inventors: Takeshi Fukuda, Kanagawa-ken (JP); Manabu Mizumoto, Kanagawa-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, Tokyo (JP)

(21) Appl. No.: 11/889,748

(22) Filed: Aug. 16, 2007

(30) Foreign Application Priority Data
Aug. 17, 2006 (JP) 222187/2006

(51) Int. Cl. G01B 11/14

(52) U.S. Cl. 356/614

(57) ABSTRACT

A drawing position measuring method is disclosed, in which a position of a drawing point is measured using detection slits formed in a drawing surface when the drawing surface and an exposure head that modulates incoming light and forms the drawing point on the drawing surface are moved relatively to each other and the exposure head sequentially forms the drawing point on the drawing surface to draw an image during the relative movement. In this method, a relative positional deviation between the exposure head and the detection slits during the relative movement is measured, and the position of the drawing point measured using the detection slits is corrected based on the measured positional deviation.

### BACKGROUND OF THE INVENTION

1. Field of the Invention

The present invention relates to a method and an apparatus for measuring a drawing position, as well as a method and an apparatus for drawing an image, in which a position of a drawing point is measured when a drawing point forming means sequentially forms the drawing point on a drawing surface to draw an image while the drawing surface and a drawing point forming means for modulating incoming light and forming the drawing point on the drawing surface are moved relatively to each other.

2. Description of the Related Art

In recent years, exposing apparatuses have been developed, which use, for example, a spatial light modulating element such as a digital micromirror device (DMD) to modulate light beams according to image data to carry out image exposure on a member to be exposed.

The DMD is a mirror device formed by a number of micromirrors arranged two-dimensionally on a semiconductor substrate such as silicon, in which the angle of a reflecting surface of each micromirror can be changed according, for example, to a control signal. The angle of the reflecting surface of each micromirror is changed by an electrostatic force due to a charge accumulated in each memory cell.

In the exposing apparatus using the DMD as described above, for example, an exposure head is used in which a laser beam emitted from a laser light source is collimated by a lens system, and the laser beam is reflected by multiple micromirrors of the DMD positioned at a substantial focal position of the lens system, and beams are emitted through multiple beam exit windows. The beams are focused on an exposure surface of a photosensitive material (a member to be exposed) with spot diameters of the beams being reduced by a lens system having an optical element such as a microlens array that condenses the beams emitted from the beam exit windows of the exposure head such that each beam for each pixel is condensed by one lens, to achieve high resolution image exposure.

In the exposing apparatus, each micromirror of the DMD is controlled on or off by a controller based on a control signal generated according to image data or the like to modulate the laser beam, and the modulated laser beams are applied to the exposure surface to expose the surface.

In the exposing apparatus, a photosensitive material (such as photoresist) is placed on the exposure surface, and positions of the focused beam spots of laser beams applied to the photosensitive material from the multiple exposure heads of the exposing apparatus are moved relatively to the photosensitive material, while the DMD of each exposure head is modulated according to image data, to achieve pattern exposure on the photosensitive material.

For example, in a case where the exposing apparatus as described above is used for exposing a circuit pattern on a substrate with high accuracy, since lenses used in the illumination optical system and the imaging optical system of the exposure head have inherent distortion property called “distortion”, a projection image on a reflecting surface formed by all the micromirrors of the DMD and that on the exposure surface may not have a correct similarity relationship, that is, the projection image on the exposure surface may be deformed due to the distortion to cause positional deviation and may not precisely correspond to the designed circuit pattern.

In order to address this problem, methods for correcting the above-described distortion have been proposed. For example, U.S. Pat. No. 7,248,338 proposes a method for correcting distortion, in which substantially L-shaped slits and photosensors for detecting light passing through the slits are provided at an end of the exposure surface, laser beams emitted from the micromirrors of the DMD and passing through the substantially L-shaped slits are detected and the position of the exposure surface at the time point of detection is measured to measure positions of beam spots from the respective micromirrors of the DMD. Then, a relative positional deviation is calculated from positional information of each beam spot and positional information of the reflecting surface of each micromirror of the DMD, and image data is corrected based on the positional deviation.

However, in the method described in U.S. Pat. No. 7,248,338, measurement of a precise beam spot position cannot be achieved if a relative positional relationship between the substantially L-shaped slit and the exposure head is deviated by disturbance such as vibration during the measurement of the beam spot position, and therefore high-precision circuit pattern exposure cannot be achieved.

### SUMMARY OF THE INVENTION

In view of the above-described circumstances, the present invention is directed to provide a method and an apparatus for measuring a drawing position which allow measurement of a beam spot position with higher accuracy for achieving higher precision image drawing, as well as a method and an apparatus for drawing an image.

A first aspect of the drawing position measuring method of the invention is a method for measuring a position of a drawing point by a position measuring means when a drawing surface and a drawing point forming means for modulating incoming light and forming the drawing point on the drawing surface are moved relatively to each other and the drawing point forming means sequentially forms the drawing point on the drawing surface to draw an image during the relative movement, the method including: measuring a relative position between each drawing point formed by the drawing point forming means and the position measuring means during the relative movement; and determining the position of the drawing point based on the measured relative position.

A second aspect of the drawing position measuring method of the invention is a method for measuring a position of a drawing point by a position measuring means when a drawing surface and a drawing point forming means for modulating incoming light and forming the drawing point on the drawing surface are moved relatively to each other and the drawing point forming means sequentially forms the drawing point on the drawing surface to draw an image during the relative movement, the method including: measuring a relative positional deviation between each drawing point formed by the drawing point forming means and the position measuring means during the relative movement; and correcting the position of the drawing point measured by the position measuring means based on the measured positional deviation.

In the first and second aspects of the drawing position measuring method of the invention, the position measuring means may include at least two slits formed in substantially the same surface as the drawing surface, the at least two slits being not parallel to each other, and a detecting means for detecting the light modulated by the drawing point forming means and passing through the at least two slits. In this case, the position of the drawing point may be measured based on each positional information of the relatively moved drawing surface corresponding to each time point of detection of the light passing through the at least two slits.

Alternatively, the position measuring means may include at least three slits formed in substantially the same surface as the drawing surface, at least two of the slits being not parallel to each other, and a detecting means for detecting the light modulated by the drawing point forming means and passing through the at least three slits. In this case, the position of the drawing point may be measured based on each positional information of the relatively moved drawing surface corresponding to each time point of detection of the light passing through the at least three slits.

As the position measuring means, a plurality of position measuring means may be used.

The slits may be formed in a glass plate.

The slits may be formed in a single glass plate.

A first aspect of the drawing position measuring apparatus of the invention includes: drawing point forming means for modulating incoming light and forming a drawing point on a drawing surface; moving means for moving the drawing point forming means and the drawing surface relatively to each other; position measuring means for measuring a position of the drawing point when the drawing point forming means sequentially forms the drawing point on the drawing surface to draw an image during the relative movement caused by the moving means; relative position measuring means for measuring a relative position between each drawing point formed by the drawing point forming means and the position measuring means during the relative movement caused by the moving means; and calculating means for determining the position of the drawing point based on the relative position measured by the relative position measuring means.

A second aspect of the drawing position measuring apparatus of the invention includes: drawing point forming means for modulating incoming light and forming a drawing point on a drawing surface; moving means for moving the drawing point forming means and the drawing surface relatively to each other; position measuring means for measuring a position of the drawing point when the drawing point forming means sequentially forms the drawing point on the drawing surface to draw an image during the relative movement caused by the moving means, the position measuring means being disposed at the drawing surface; positional deviation measuring means for measuring a relative positional deviation between each drawing point formed by the drawing point forming means and the position measuring means during the relative movement caused by the moving means; and correcting means for correcting the position of the drawing point measured by the position measuring means based on the positional deviation measured by the positional deviation measuring means.

In the first and second aspects of the drawing position measuring apparatus of the invention, the position measuring means may include at least two slits formed in substantially the same surface as the drawing surface, the at least two slits being not parallel to each other, and a detecting means for detecting the light modulated by the drawing point forming means and passing through the at least two slit. In this case, the position of the drawing point may be measured based on each positional information of the relatively moved drawing surface corresponding to each time point of detection of the light passing through the at least two slits.

Alternatively, the position measuring means may include at least three slits formed in substantially the same surface as the drawing surface, at least two of the slits being not parallel to each other, and a detecting means for detecting the light modulated by the drawing point forming means and passing through the at least three slits. In this case, the position of the drawing point may be measured based on each positional information of the relatively moved drawing surface corresponding to each time point of detection of the light passing through the at least three slits.

As the position measuring means, a plurality of position measuring means may be used.

The slits may be formed in a glass plate.

The slits may be formed in a single glass plate.

### BRIEF DESCRIPTION OF THE DRAWINGS

FIG. 1 is an overall schematic perspective view illustrating an exposing apparatus employing one embodiment of an apparatus for measuring a drawing position of the present invention,

FIG. 2 is a schematic perspective view illustrating a photosensitive material being exposed by exposure heads of an exposure head unit,

FIG. 3 is a diagram illustrating the schematic configuration of an optical system relating to the exposure head,

FIG. 4 is an enlarged perspective view illustrating the structure of a DMD,

FIGS. 5A and 5B are diagrams for explaining operation of the DMD,

FIG. 6A is a plan view illustrating scan trajectories of a reflected light image (exposure beams) reflected by micromirrors when the DMD is not tilted,

FIG. 6B is a plan view illustrating scan trajectories of the exposure beams when the DMD is tilted,

FIG. 7 is a diagram illustrating detection slits for an exposure area of one exposure head,

FIG. 8A is a diagram for explaining how a position of a certain pixel in the “on” state is detected using the detection slit,

FIG. 8B is a diagram illustrating signals when the certain pixel in the “on” state is detected by a photosensor,

FIG. 9 is a diagram for explaining how the certain pixel in the “on” state is detected using the detection slit,

FIG. 10 is a diagram for explaining how a relative positional deviation between the exposure head and the detection slit is measured,

FIG. 11 is a diagram showing an angle θ formed between the detection slit and X-direction,

FIG. 12 is a diagram illustrating another embodiment of the detection slit,

FIG. 13 is a diagram illustrating yet another embodiment of the detection slit,

FIG. 14 is a diagram illustrating how multiple certain pixels in the “on” state are detected using multiple detection slits,

FIG. 15 is a diagram for explaining an amount of drawing distortion (distortion condition) detected by a distortion amount detecting means, and

FIGS. 16A to 16F are diagrams for explaining correction of the drawing distortion.

### DESCRIPTION OF THE PREFERRED EMBODIMENTS

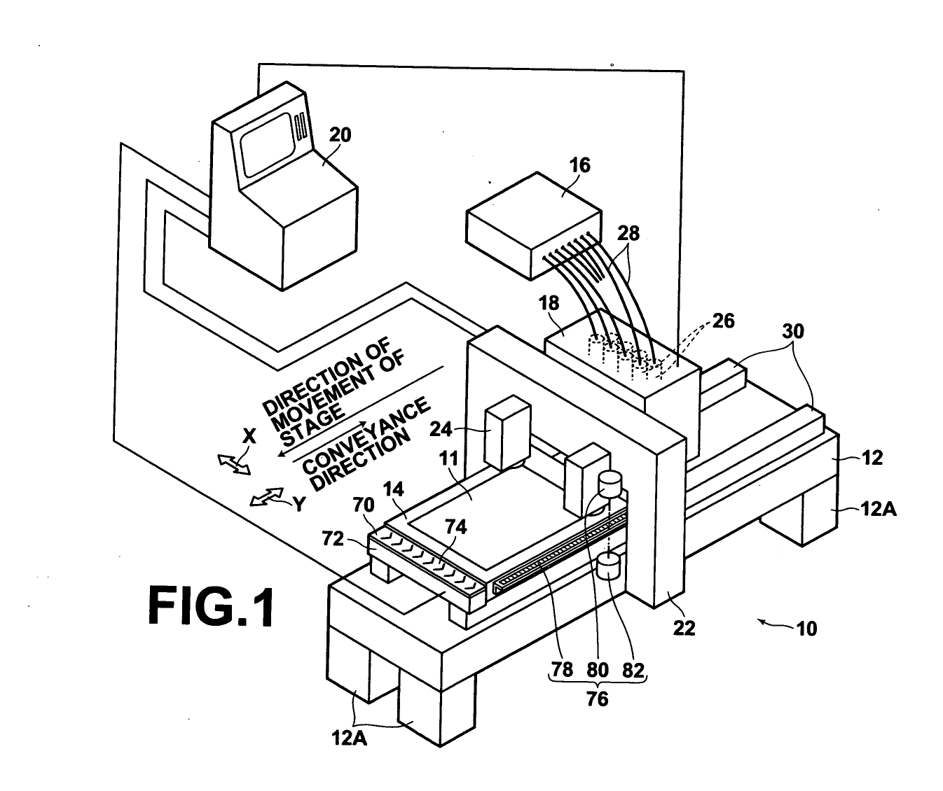

Hereinafter, an exposing apparatus which employs one embodiment of the method and apparatus for measuring a drawing position of the present invention will be described in detail with reference to the drawings. FIG. 1 is a perspective view showing the schematic configuration of the exposing apparatus employing one embodiment of the invention.

As shown in FIG. 1, an exposing apparatus 10 is configured as a so-called flat bed-type apparatus, and includes: a base 12 supported by four leg members 12A; a moving stage 14 disposed on the base 12 and moving in Y-direction in the drawing, on which a photosensitive material is placed and fixed; a light source unit 16 for emitting laser light including light in the ultraviolet wavelength range in a form of multiple beams extending in one direction; an exposure head unit 18 for applying spatial modulation to the multiple beams according to positions of the multiple beams based on desired image data and applying the modulated multiple beams serving as exposure beams to a photosensitive material which is sensitive to the wavelength range of the multiple beams; and a controlling unit 20 for generating modulation signals from the image data, which are provided to the exposure head unit 18 along with the movement of the moving stage 14.

In the exposing apparatus 10, the exposure head unit 18 for exposing the photosensitive material is disposed above the moving stage 14. The exposure head unit 18 includes multiple exposure heads 26. Each exposure head 26 has an optical fiber bundle 28, which is drawn from the light source unit 16, connected thereto.

The exposing apparatus 10 includes a gate-shaped frame 22 which straddles the base 12, and a pair of position detection sensors 24 disposed at one side of the frame 22. The position detection sensors 24 provide a detection signal to the controlling unit 20 when they detect passage of the moving stage 14.

The exposing apparatus 10 further includes two guides 30 disposed on the upper surface of base 12 and extending in the direction of movement of the stage. The moving stage 14 is mounted on the two guides 30 so that it can reciprocate along the guides 30. The moving stage 14 is moved by a linear motor (not shown) at a relatively low constant speed, such as 40 mm/second, over a travel distance of 1000 mm, for example.

In the exposing apparatus 10, a photosensitive material (substrate) 11, which is a member to be exposed, placed on the moving stage 14 is moved relative to the fixed exposure head unit 18 to effect scan exposure.

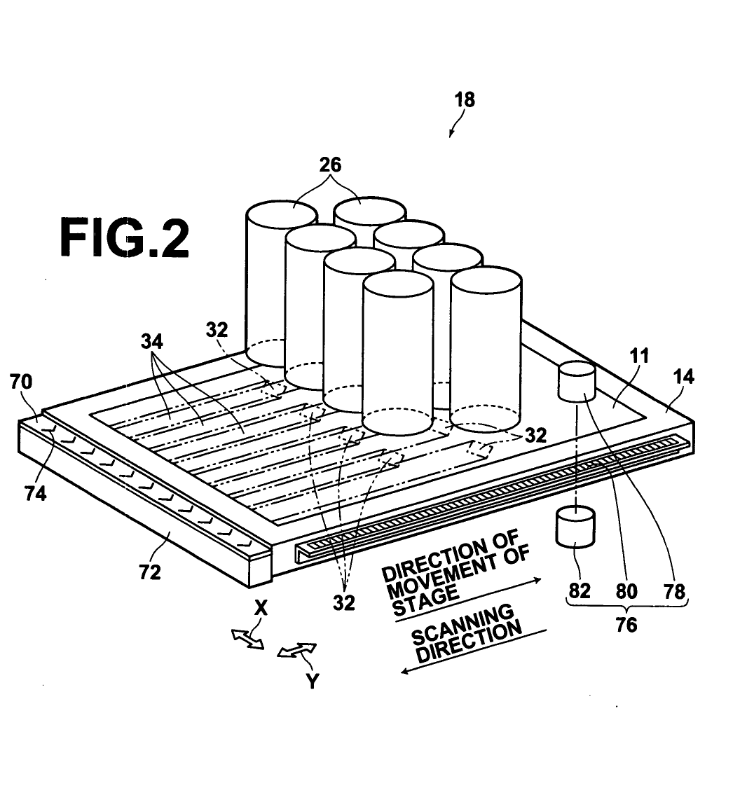

As shown in FIG. 2, the exposure head unit 18 includes multiple (eight, for example) exposure heads 26 which are arrayed in a substantial matrix of m rows and n columns (for example, two rows and four columns).

An exposure area 32 of the exposure heads 26 is, for example, a rectangle with short sides in the scanning direction. In this case, a band-like exposed area 34 is formed on the photosensitive material 11 by each exposure head 26 along with the movement for effecting the scan exposure.

Further, as shown in FIG. 2, the rows of linearly arranged exposure heads 26 are offset from each other in the direction of the row by a predetermined distance (obtained by multiplying the long side of the exposure area by a natural number) so that the band-like exposed areas 34 are arranged without a gap therebetween in the direction perpendicular to the scanning direction. For example, unexposed portions between the exposure areas 32 of the first row of exposure heads 26 are exposed by the exposure areas 32 of the second row of exposure heads 26.

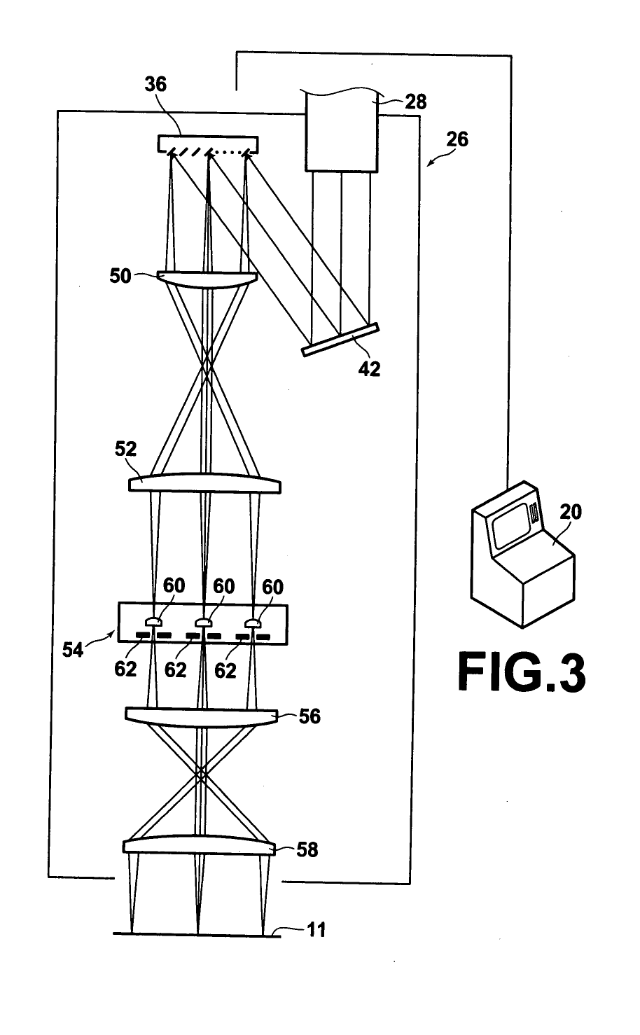

As shown in FIG. 3, each exposure head 26 includes a digital micromirror device (DMD) 36, which serves as a spatial light modulating element for modulating incoming light beam for each pixel according to image data. The DMD 36 is connected to the controlling unit (controlling means) 20, which includes a data processing means and a mirror driving means.

At the data processing means in the controlling unit 20, a control signal for driving each micromirror within an area to be controlled of the DMD 36 of each exposure head 26 is generated based on the inputted image data. Further, the mirror driving means serving as a DMD controller controls the angle of the reflecting surface of each micromirror in the DMD 36 of each exposure head 26, based on the control signal generated at the data processing means. The control on the angle of the reflecting surface will be described later.

As shown in FIG. 1, each optical fiber bundle 28 drawn from the light source unit 16, which serves as a lighting device for emitting laser light in the form of multiple beams containing light in the ultraviolet wavelength range and extending in one direction, is connected to the DMD 36 of each exposure head 26 at the light-input side thereof.

Although not shown in the drawings, the light source unit 16 contains multiple combining modules for combining laser light emitted from multiple semiconductor laser chips and input the combined light to the optical fibers. The optical fibers extending from each combining module serve as combining optical fibers for propagating the combined laser light, and the multiple optical fibers are bundled to form the optical fiber bundle 28.

As shown in FIG. 3, a mirror 42 for reflecting the laser light emitted from the coupled end of the optical fiber bundle 28 toward the DMD 36 is disposed on the light-input side of the DMD 36 of each exposure head 26.

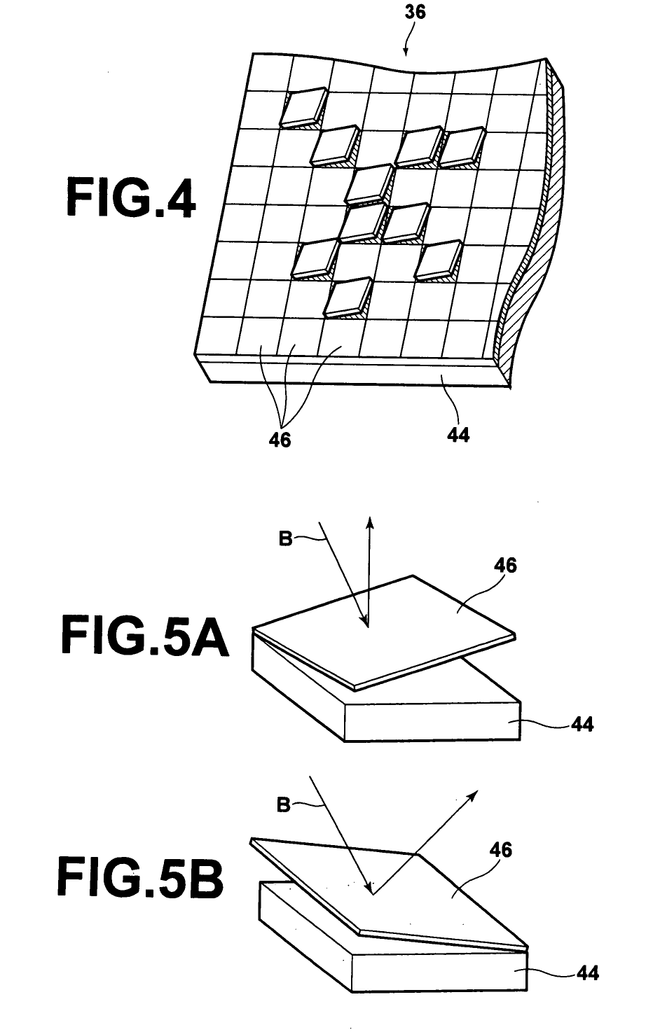

As shown in FIG. 4, the DMD 36 is formed by micromirrors 46 which are supported on SRAM cells (memory cells) 44 by supporting posts. The DMD 36 is configured as a mirror device having a number of (600×800, for example) micromirrors forming pixels, arranged in a form of lattice. Each pixel has one micromirror 46 supported at the top by the supporting post. The surface of the micromirror 46 has a vapor-deposited material having high reflectance, such as aluminum.

The SRAM cell 44 of a silicon gate CMOS, which is produced on a usual semiconductor memory production line, is disposed just under the micromirror 46 via the supporting post including a hinge and a yoke (not shown).

As a digital signal is written in the SRAM cell 44 of the DMD 36, the micromirror 46 supported by the supporting post is tilted around the diagonal line within a range of ±a degrees (±10 degrees, for example) with respect to the substrate on which the DMD 36 is disposed. FIG. 5A shows the micromirror 46 in the “on” state in which the micromirror 46 is tilted by an angle of +a degrees, and FIG. 5B shows the micromirror 46 in the “off” state in which the micromirror 46 is tilted by an angle of −a degrees. Thus, by controlling the inclination of the micromirror 46 for each pixel of the DMD 36 according to an image signal, as shown in FIG. 4, the light entering the DMD 36 is reflected in the direction of inclination of each micromirror 46.

It should be noted that FIG. 4 shows an enlarged portion of the DMD 36, illustrating one example where the micromirrors 46 are controlled to be tilted by +a degrees or −a degrees. The control for setting each micromirror 46 in the “on” or “off” state is carried out by the controlling unit 20 connected to the DMD 36. The light reflected by the micromirror 46 in the “on” state is modulated into exposing state and enters a projection optical system (see FIG. 3) disposed on the light-output side of the DMD 36. The light reflected by the micromirror 46 in the “off” state is modulated into non-exposing state and enters a light absorber (not shown).

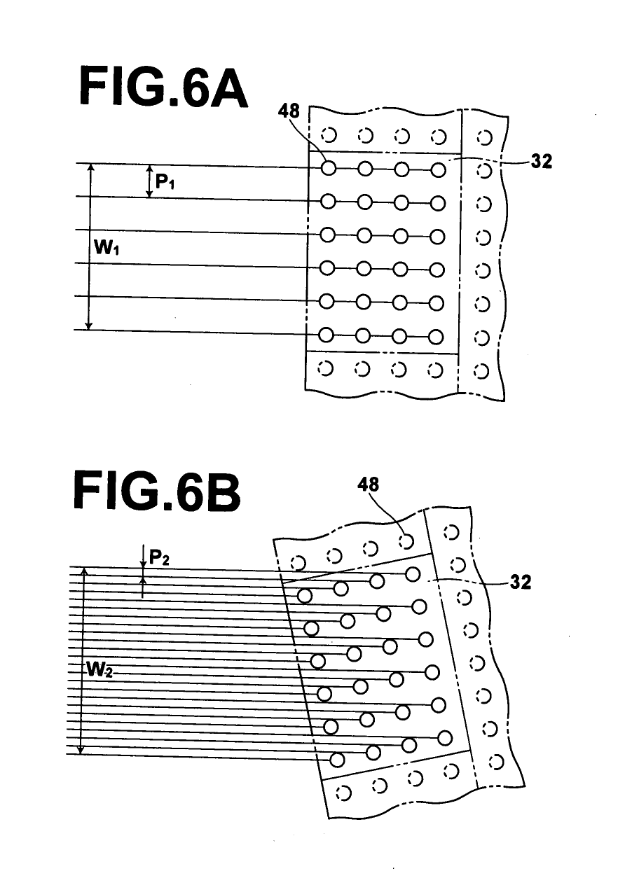

The DMD 36 may be disposed such that the direction of the short sides thereof is slightly inclined with respect to the scanning direction to form a predetermined angle (ranging from 0.1° to 0.5°, for example) therebetween. FIG. 6A shows scan trajectories of a reflected light image (exposure beams) 48 reflected by the respective micromirrors when the DMD 36 is not tilted, and FIG. 6B shows scan trajectories of the exposure beams 48 when the DMD 36 is tilted.

The DMD 36 includes a number of (600, for example) rows of micromirrors arranged in the short-side direction, each row including a number of micromirrors 46 (800, for example) in the long-side direction (the direction of the row). By tilting the DMD 36 as shown in FIG. 6B, the scan trajectories (scan lines) of the exposure beams 48 reflected by the micromirrors 46 has a pitch P2 which is smaller than a pitch P1 of the scan lines when the DMD 36 is not tilted, and this can greatly increase the resolution. Since the angle of inclination of the DMD 36 is very small, a scan width W2 of the tilted DMD 36 is substantially the same as a scan width W1 of the untilted DMD 36.

It should be noted that, in stead of tilting the DMD 36, the rows of micromirrors can be offset from each other in a direction perpendicular to the scanning direction by a predetermined distance to obtain the same effect.

Next, the projection optical system (imaging optical system) disposed on the light-reflecting side of the DMD 36 in the exposure head 26 will be explained. As shown in FIG. 3, the projection optical system disposed on the light-reflecting side of the DMD 36 in each exposure head 26 includes optical members for exposure, i.e., lens systems 50, 52, a microlens array 54 and objective lens systems 56, 58 which are disposed in this order from the DMD 36 toward the photosensitive material 11, for projecting a light source image on the photosensitive material 11 placed on the exposure surface on the light-reflecting side of the DMD 36.

The lens systems 50, 52 are configured as an enlarging optical system, which enlarges the sectional area of a bundle of rays reflected by the DMD 36 to enlarge the area of the exposure area 32 on the photosensitive material 11 (shown in FIG. 2) formed by the bundle of rays reflected by the DMD 36 to a desired size.

As shown in FIG. 3, the microlens array 54 is formed by integrally-formed multiple microlenses 60, which correspond one-to-one to the micromirrors 46 of the DMD 36 for reflecting laser light emitted via the optical fibers 28 from the light source unit 16. Each microlens 60 is disposed in the optical axis of each laser beam passing through the lens systems 50, 52.

The microlens array 54 is formed as a rectangle flat plate, and each portion thereof forming the microlens 60 has an integrally-disposed aperture 62. The aperture 62 is configured to serve as an aperture stop for each corresponding microlens 60.

As shown in FIG. 3, the objective lens systems 56, 58 are formed, for example, as an optical system with a magnification ratio of 1:1. The photosensitive material 11 is placed in a focal position on the downstream side of the objective lens systems 56, 58. It should be noted that, although each of the lens systems 50, 52 and the objective lens systems 56, 58 in the projection optical system is shown in FIG. 3 as a single lens, each lens system may be formed by a combination of multiple lenses (for example, a convex lens and a concave lens).

In the exposing apparatus 10 having the above-described configuration, a drawing distortion amount detecting means is provided for appropriately detecting an amount of drawing distortion due to distortion of the lens systems 50, 52 and/or the objective lens systems 56, 58 in the projection optical system of the exposure head 26, and/or changes in temperature during exposure operation at the exposure head 26.

As a part of the drawing distortion amount detecting means, the exposing apparatus 10 includes a beam position measuring means for measuring positions of the applied beams, disposed at the upstream in the conveyance direction of the moving stage 14, as shown in FIGS. 1 to 3.

The beam position measuring means includes a slit plate 70 attached integrally to an upstream edge of the moving stage 14 along the direction perpendicular to the conveyance direction (scanning direction), and photosensors 72 disposed at the back side of the slit plate 70 correspondingly to slits of the slit plate 70.

The slit plate 70 has detection slits 74, through which the laser beams emitted from the exposure head 26 pass.

The slit plate 70 may be formed of quartz glass, which is not likely to deform due to changes in temperature.

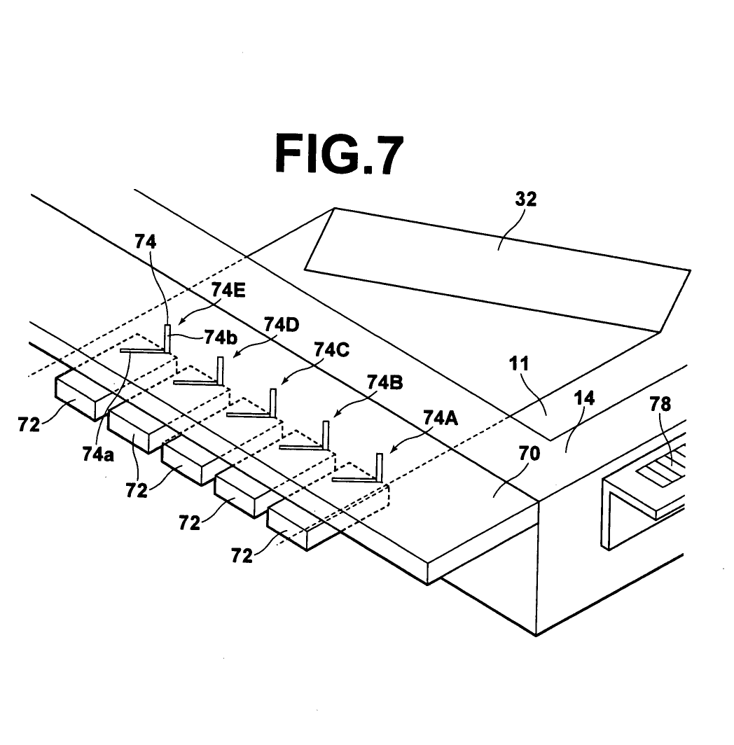

As shown in FIG. 7, each detection slit 74 is formed by a straight-line first slit portion 74a at the upstream in the conveyance direction and having a predetermined length and a straight-line second slit portion 74b at the downstream in the conveyance direction and having a predetermined length, which are connected to each other at one ends thereof to form a right angle therebetween.

Namely, the first slit portion 74a and the second slit portion 74b are perpendicular to each other, and the first slit portion 74a forms an angle of 135 degrees with respect to Y-axis (the direction of travel) and the second slit portion 74b forms an angle of 45 degrees with respect to the Y-axis. It should be noted that, in this embodiment, the scanning direction corresponds to the Y-axis and, and the direction perpendicular to the scanning direction (the direction of the rows of exposure heads 26) corresponds to X-axis.

It should be noted that the first slit portion 74a and the second slit portion 74b only need to be arranged to form a predetermined angle therebetween, and may not necessarily intersect with each other. The first slit portion 74a and the second slit portion 74b may be apart from each other.

In this exposing apparatus, in order to obtain good S/N to allow highly accurate measurement even if a beam spot BS to be measured by the beam position measuring means has a low amount of light, a slit width of the first slit portion 74a and the second slit portion 74b of the detection slit 74 is formed to be greater than the diameter of the beam spot BS of a Gaussian beam so that the photosensor 72 can receive a sufficient amount of light. In short, the slit width of the first slit portion 74a and the second slit portion 74b of the detection slit 74 is formed to be greater than the beam spot BS of the Gaussian beam.

By forming the slit width of the detection slit 74 to be greater than the diameter of the beam spot BS so that the photosensor 72 can receive a sufficient amount of light, the amount of light of the beam applied at the beam spot BS can fully be utilized to increase the amount of light received by the photosensor 72 as large as possible. Thus, good S/N can be obtained.

As generally defined, the Gaussian beam refers to a beam that has a Gaussian distribution, which is symmetrical about the center, in the intensity at the cross section perpendicular to the beam.

Further, the diameter of the beam spot of the Gaussian beam refers to a diameter of an area in which the intensity of the beam is not less than 1/e² (about 13.5%) of the intensity at the central axis of the beam.

The photosensor 72 (CCD, CMOS, photodetector, or the like) for detecting the light from the exposure head 26 is disposed at a predetermined position just below each detection slit 74.

As shown in FIG. 1, the beam position measuring means provided in the exposing apparatus 10 includes a linear encoder 76 for detecting the position of the moving stage 14, disposed at one of the sides of the moving stage 14 along the conveyance direction of the moving stage 14.

The linear encoder 76 can be a commercially-available linear encoder. The linear encoder 76 includes a scale plate 78, which is integrally attached at the side of the moving stage 14 along the conveyance direction (scanning direction) of the moving stage 14 and has a scale formed by equally-spaced small slits provided in a flat portion for allowing light to pass therethrough, as well as a projector 80 and a photoreceiver 82 which are provided at the base 12 on the opposite sides of the scale plate 78 and fixed to a fixing frame (not shown).

The linear encoder 76 is configured such that the projector 80 emits a measurement beam and the photoreceiver 82 disposed at the opposite side detects the measurement beam passing through the slits of the scale plate 78 and sends detection signals to the controlling unit 20.

At the linear encoder 76, as the moving stage 14 is moved from the initial position, the measurement beam emitted from the projector 80 enters the photoreceiver 82 with being intermittently blocked by the scale plate 78 moving together with the moving stage 14.

Then, in the exposing apparatus 10, the controlling unit 20 counts the number of receptions of the beam at the photoreceiver 82 to identify the position of the moving stage 14.

The controlling unit 20 of the exposing apparatus 10 includes an electrical system which forms a part of the distortion amount detecting means.

The controlling unit 20 includes a CPU and a memory serving as a control device. The control device is configured to be able to drive the individual micromirrors 46 of the DMD 36.

The control device receives the output signals from the photoreceiver 82 of the linear encoder 76 and the output signals from the photosensors 72, and applies distortion correction to the image data based on information associating positions of the moving stage 14 with states of the output from the photosensor 72. Then, the control device generates appropriate control signals to control the DMD 36, and drives the moving stage 14 carrying the photosensitive material 11 in the scanning direction.

The control device also controls various units relating to the entire exposure operation of the exposing apparatus 10 and necessary for the exposure at the exposing apparatus 10, such as the light source unit 16.

Next, a method for measuring a beam position using the detection slits 74 and the linear encoder 76 at the drawing distortion amount detecting means provided in the exposing apparatus 10 will be explained.

First, explanation is given on how the actual position of a beam spot formed on the exposure surface when a certain pixel Z1, which is a pixel to be measured, is turned on is identified using the detection slits 74 and the linear encoder 76 in the exposing apparatus 10.

Initially, the moving stage 14 is moved to position a predetermined detection slit 74, which corresponds to a predetermined exposure head 26, of the slit plate 70 below the exposure head unit 18.

Subsequently, control is exerted such that only the certain pixel Z1 of a predetermined DMD 36 is turned on (“on” state).

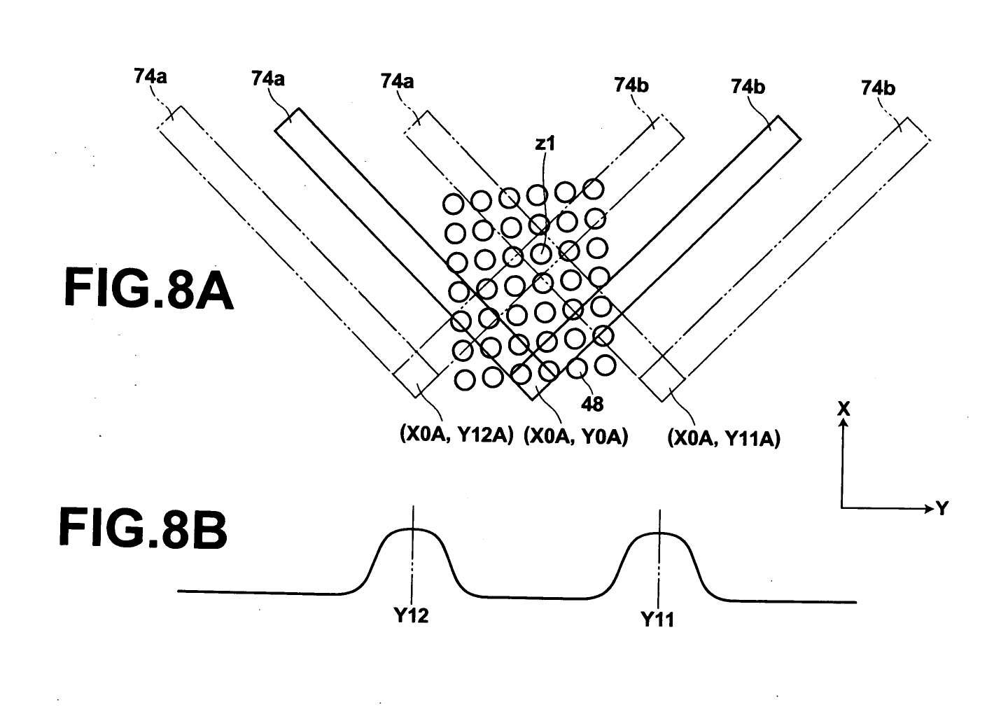

Then, the moving stage 14 is further moved so that the detection slit 74 is moved to a required position in the exposure area 32 (for example, a position to be the point of origin), as shown by the solid line in FIG. 8A. At this time, the control device identifies the intersection point of the first slit portion 74a and the second slit portion 74b as (X0,Y0) and stores this information in the memory.

Then, as shown in FIG. 8A, the control device moves the moving stage 14 so that the detection slit 74 moves to the right along the Y-axis in FIG. 8A.

Then, the control device calculates positional information of the certain pixel Z1 from a relationship between the position of the moving stage 14 and an output signal outputted when the slit 74 passes the position shown by the imaginary line at the right in FIG. 8A and the light from the turned-on certain pixel Z1 passes through the first slit portion 74a and is detected by the photosensor 72 as shown in the example of FIG. 8B, and then obtains the intersection point (X0,Y11) of the first slit portion 74a and the second slit portion 74b.

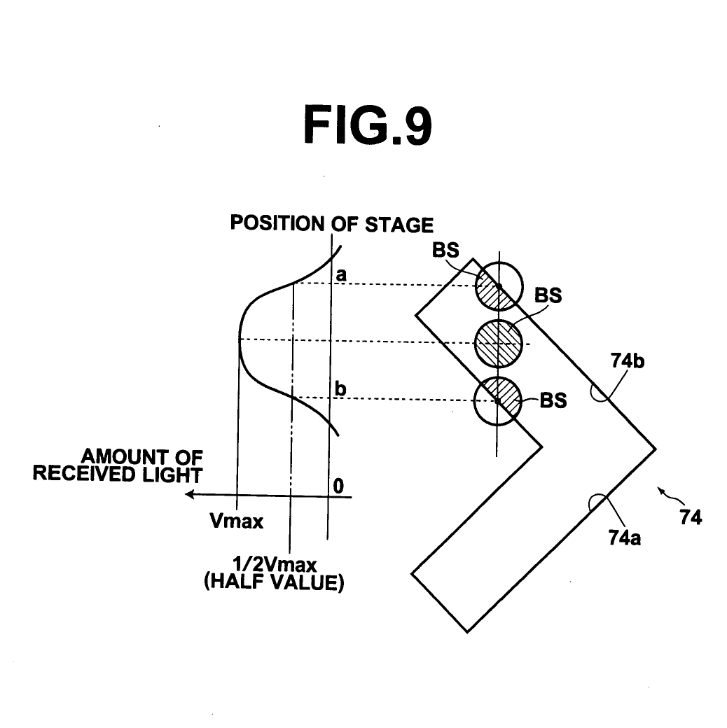

In the beam position measuring means, since the slit width of the detection slit 74 is formed to be sufficiently greater than the diameter of the beam spot BS, the maximum detection value is obtained by the photosensor 72 at positions within a certain range as shown in FIG. 9, and therefore the position at which the maximum detection value is obtained by the photosensor 72 cannot simply be identified as the position of the certain pixel Z1.

Therefore, a half value which is a half the maximum value detected by the photosensor 72 is calculated. Then, the control device finds two positions (positions of the moving stage 14) at which the output from the photosensor 72 is the half value based on the detection values outputted from the linear encoder 76 while the moving stage 14 continuously moves.

Then, a center position between a first position a and a second position b of the two positions at which the output from the photosensor 72 is the half value is calculated. The calculated center position is taken as the positional information of the certain pixel Z1 (the intersection point (X0,Y11) of the first slit portion 74a and the second slit portion 74b). In this manner, the center position of the beam spot BS as the position of the certain pixel Z1 can be found.

The positional information (X0,Y11) of the certain pixel Z1 can be obtained as described above. However, if the relative positional relationship between the detection slit 74 and the exposure head 26 is deviated due to, for example, disturbance during measurement by the beam position measuring means, precise positional information of the certain pixel Z1 cannot be obtained without correcting the positional deviation. Therefore, in the exposing apparatus of this embodiment, correction of the positional deviation due to disturbance as described above is carried out. That is, a precise beam position is determined by calculating the beam position with synchronizing the “positional information measured by the detection slit” and a “relative positional movement value between the moving stage and the exposure head (a measurement value taking all of an external measurement by end-measuring machines, a feed amount of the moving stage and disturbance into account)”.

Specifically, first, a relative positional deviation between the exposure head 26 and the detection slit 74 is measured.

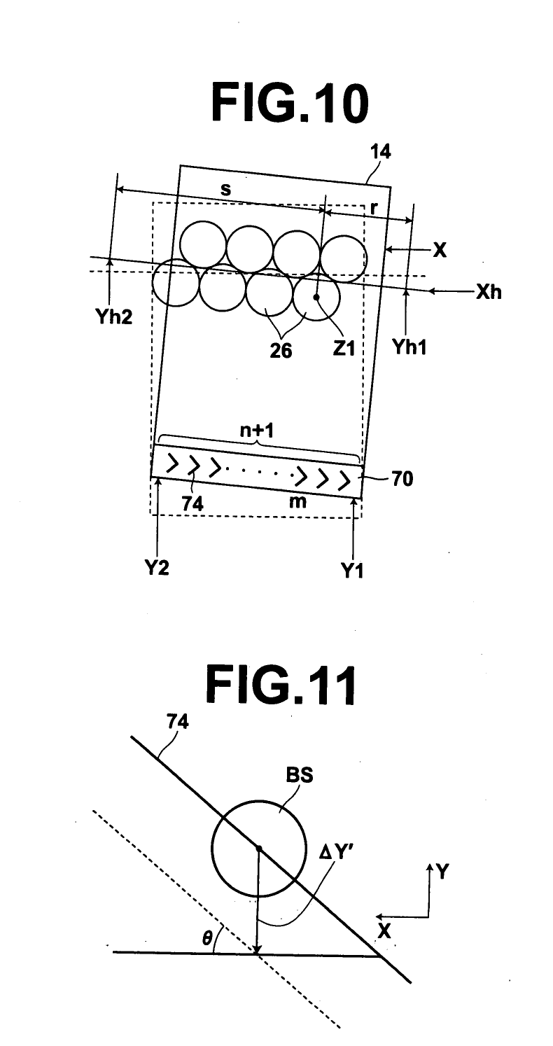

The relative positional deviation between the exposure head 26 and the detection slit 74 is measured by measuring a positional deviation of the moving stage 14 at which the detection slit 74 is provided and a positional deviation of the exposure head 26. As shown in FIG. 10, a positional deviation of the moving stage 14 in the Y-direction is measured by end-measuring machines Y1, Y2, and a positional deviation of the moving stage 14 in the X-direction is measured by an end-measuring machine X. A positional deviation of the exposure head in the Y-direction is measured by end-measuring machines Yh1, Yh2, and a positional deviation of the exposure head in the X-direction is measured by an end-measuring machine Xh.

Then, the first position a is corrected based on the positional deviation measured by the end-measuring machines shown in FIG. 10. Specifically, a positional coordinate Y11a′ of the corrected first position a is obtained by calculating the formula below:

Y11a′=Y11a+(Y2a−Y1a)×m/n+(Xa−Xha)/tanθ−(Yh1a×s+Yh2a×r)/(r+s)

wherein:
Y11a represents a coordinate value in the Y-direction of the actually measured first position a;
Y2a represents a value from the end-measuring machine Y2 at the time point when the first position a is measured;
Y1a represents a value from the end-measuring machine Y1 at the time point when the first position a is measured;
Xa represents a value from the end-measuring machine X at the time point when the first position a is measured;
Xha represents a value from the end-measuring machine Xh at the time point when the first position a is measured;
Yh1a represents a value from the end-measuring machine Yh1 at the time point when the first position a is measured; and
Yh2a represents a value from the end-measuring machine Yh2 at the time point when the first position a is measured.

It should be noted that n+1 detection slits 74 are arranged at regular intervals in the X-direction, and the first position a is measured at the m-th slit from the measurement point of the end-measuring machine Y1.

Further, as shown in FIG. 11, θ is an angle formed between the detection slit 74 and the X-direction. It should be noted that the dashed line in FIG. 11 represents the slit when there is no disturbance. ΔY′ in FIG. 11 represents a sum of all the positional deviations caused by disturbance.

Similarly, a corrected positional coordinate Y11b′ of the second position b is obtained by calculating the formula below:

Y11b′=Y11b+(Y2b−Y1b)×m/n+(Xb−Xhb)/tanθ−(Yh1b×s+Yh2b×r)/(r+s)

wherein:
Y11b represents a coordinate value in the Y-direction of the actually measured second position b;
Y2b represents a value from the end-measuring machine Y2 at the time point when the second position b is measured;
Y1b represents a value from the end-measuring machine Y1 at the time point when the second position b is measured;
Xb represents a value from the end-measuring machine X at the time point when the second position b is measured;
Xhb represents a value from the end-measuring machine Xh at the time point when the second position b is measured;
Yh1b represents a value from the end-measuring machine Yh1 at the time point when the second position b is measured; and
Yh2b represents a value from the end-measuring machine Yh2 at the time point when the second position b is measured.

Then, a center position between the thus obtained positional coordinates Y11a′ and Y11b′ is stored in the memory as positional information (X0,Y11′) of the corrected certain pixel Z1.

Subsequently, the moving stage 14 is moved to move the detection slit 74 along the Y-axis to the left in FIG. 8A. Then, in the same manner as explained above with respect to FIG. 9, the control device finds a first position c and a second position d from a relationship between the position of the moving stage 14 and an output signal outputted from the photosensor 72 when the light from the turned-on certain pixel Z1 shown in the example of FIG. 8B passes through the second slit portion 74b in the position shown by the imaginary line at the left in FIG. 8A and is detected by the photosensor 72. Then, in the same manner as described above, a positional coordinate Y11c of the first position c and a positional coordinate Y11d of the second position d are corrected based on the positional deviation measured by the end-measuring machines, and the corrected positional coordinate Y11c′ of the first position c and the corrected positional coordinate Y11d′ of the second position d are obtained. Then, a center position between these corrected positional coordinates is stored in the memory as positional information (X0,Y12′) of the corrected certain pixel Z1.

Subsequently, the control device reads out the coordinates (X0,Y11′) and (X0,Y12′) stored in the memory and obtains coordinate (X1,Y1) of the certain pixel Z1 according to the following formula:

X1=X0+(Y11′−Y12′)/2

Y1=(Y11′+Y12′)/2

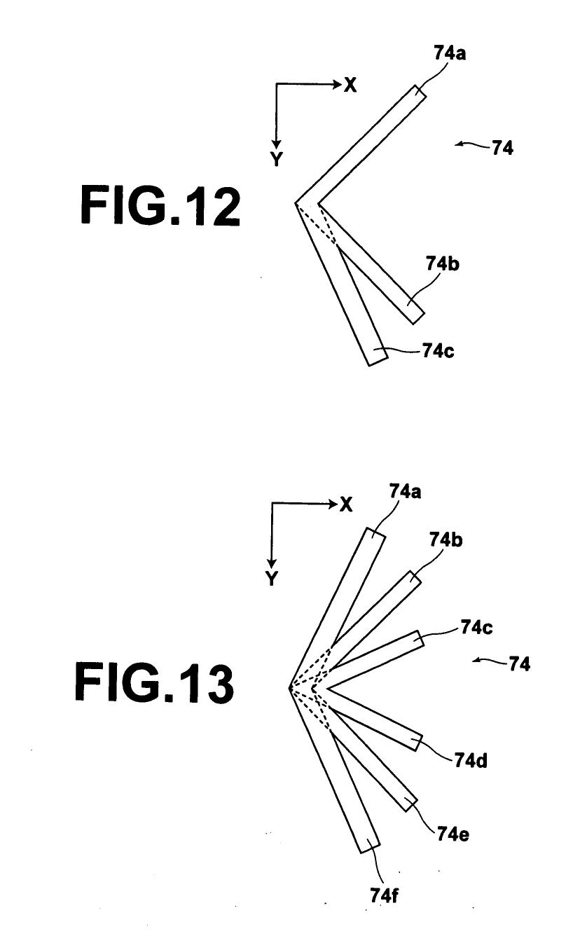

It should be noted that, although the detection slit 74 formed by the first slit portion 74a and the second slit portion 74b is used to find the coordinates X1, Y1 of the certain pixel Z1 in the above-described embodiment, the invention is not limited to this embodiment. For example, the detection slit 74 maybe formed by three slit portions including a first slit portion 74a, a second slit portion 74b and a third slit portion 74c, as shown in FIG. 12. In this case, for example, coordinates X1A, Y1A of the certain pixel Z1 may be found using the first slit portion 74a and the second slit portion 74b and coordinates X1B, Y1B of the certain pixel Z1 may be found using the first slit portion 74a and the third slit portion 74c, in the same manner as described above, and then these coordinates may respectively be averaged to obtain the coordinates X1, Y1 of the certain pixel Z1.

Further, the detection slit 74 may be formed by six slit portions including a first slit portion 74a, a second slit portion 74b, a third slit portion 74c, a fourth slit portion 74d, a fifth slit portion 74e and a sixth slit portion 74f, as shown in FIG. 13. In this case, for example, the first slit portion 74a and the sixth slit portion 74f may be used to find coordinates X1A, Y1A of the certain pixel Z1, the second slit portion 74b and the fifth slit portion 74e may be used to find coordinates X1B, Y1B of the certain pixel Z1, and the third slit portion 74c and the fourth slit portion 74d may be used to find coordinates X1C, Y1C of the certain pixel Z1 in the same manner as described above. Then, the coordinates X1A, X1B and X1C may be averaged to obtain the coordinate X1 of the certain pixel Z1 and the coordinates Y1A, Y1B and Y1C may be averaged to obtain the coordinate Y1 of the certain pixel Z1.

Next, a method for detecting an amount of drawing distortion in the exposure area 32 of one exposure head 26 in the exposing apparatus 10 will be explained.

In order to detect the distortion amount in the exposure area 32, the exposing apparatus 10 is configured such that multiple (five in this embodiment) detection slits 74A-74E are simultaneously used for position detection for one exposure area 32, as shown in FIG. 7.

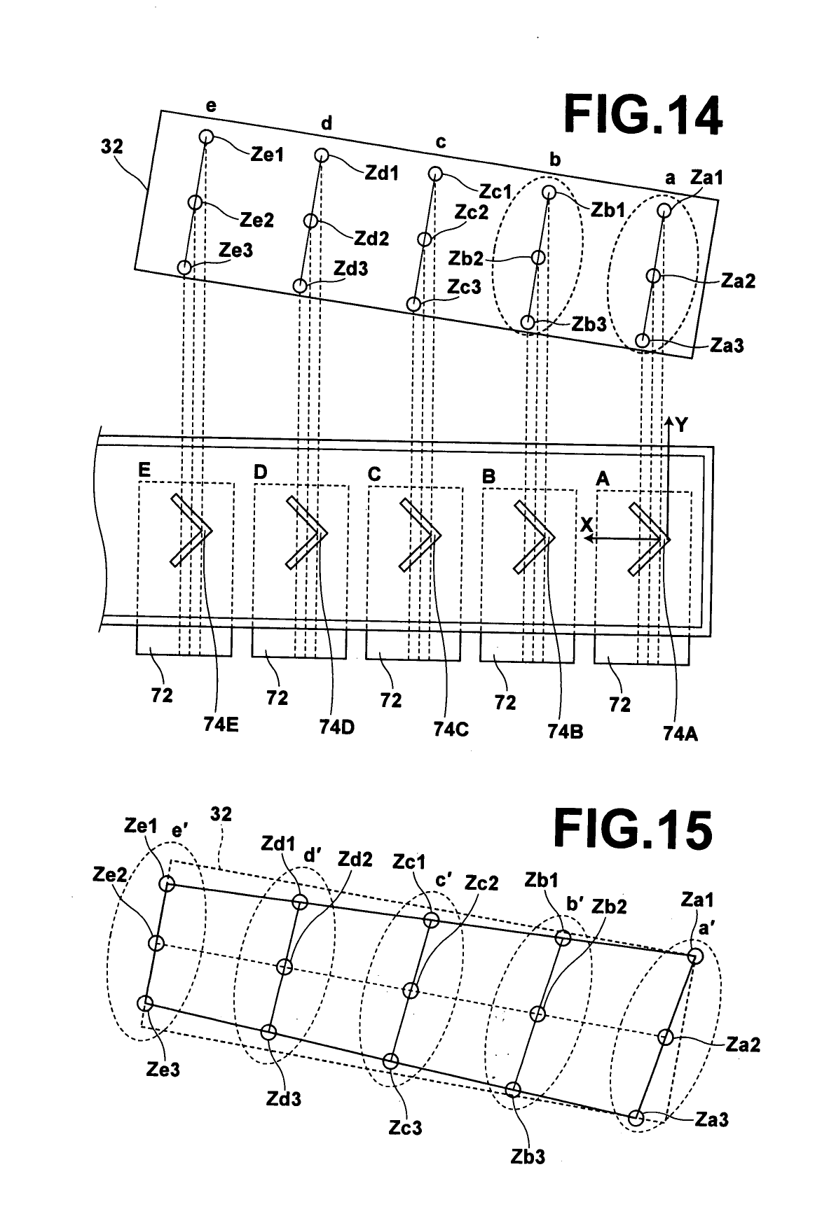

In this case, multiple pixels to be measured, which are regularly distributed over the exposure area to be measured, are set within the exposure area 32 of one exposure head 26. In this embodiment, five sets of pixels to be measured are set. These pixels to be measured are set at symmetrical positions with respect to the center of the exposure area 32. In the exposure area 32 shown in FIG. 14, a set of pixels to be measured Zc1, Zc2 and Zc3 is positioned at the center in the long-side direction (in this example, three pixels to be measured form a set), and two sets of pixels to be measured Za1, Za2 and Za3 and Zb1, Zb2 and Zb3 and another two sets of pixels to be measured Zd1, Zd2 and Zd3 and Ze1, Ze2 and Ze3 are positioned symmetrically on the right and left with respect to the set at the center.

Further, as shown in FIG. 12, the slit plate 70 includes five detection slits 74A, 74B, 74C, 74D and 74E formed at positions respectively corresponding to the sets of the pixels to be measured so as to be able to detect these sets of pixels.

To detect the distortion amount in the exposure area 32, the control device controls the DMD 36 to set the predetermined group of pixels to be measured (Za1, Za2, Za3, Zb1, Zb2, Zb3, Zc1, Zc2, Zc3, Zd1, Zd2, Zd3, Ze1, Ze2 and Ze3) in the “on” state and move the moving stage 14 with the slit plate 70 to a position directly below each exposure head 26 to find coordinates of the pixels to be measured using their corresponding detection slits 74A, 74B, 74C, 74D and 74E. At this time, the predetermined group of pixels to be measured may be set in the “on” state one by one, or all the pixels to be measured of the predetermined group may be set in the “on” state for detection.

Then, the control device finds an amount of drawing distortion (distortion condition) in the exposure area 32, as shown in the example of FIG. 15, by calculating relative positional deviations of the pixels to be measured based on positional information of the reflecting surfaces of predetermined micromirrors 46 of the DMD 36 corresponding to the pixels to be measured and positional information of exposure points of predetermined light beams projected on the exposure surface (exposure area 32) from the predetermined micromirrors, which are detected using the detection slits 74 and the linear encoder 76.

In the exposing apparatus 10 of this embodiment, since the multiple detection slits 74 are arranged in the X-direction, an amount of drawing distortion in the exposure area 32 of one exposure head 26 can be detected in the manner as described above. In addition, a positional relationship between adjacent exposure heads 26 can be found.

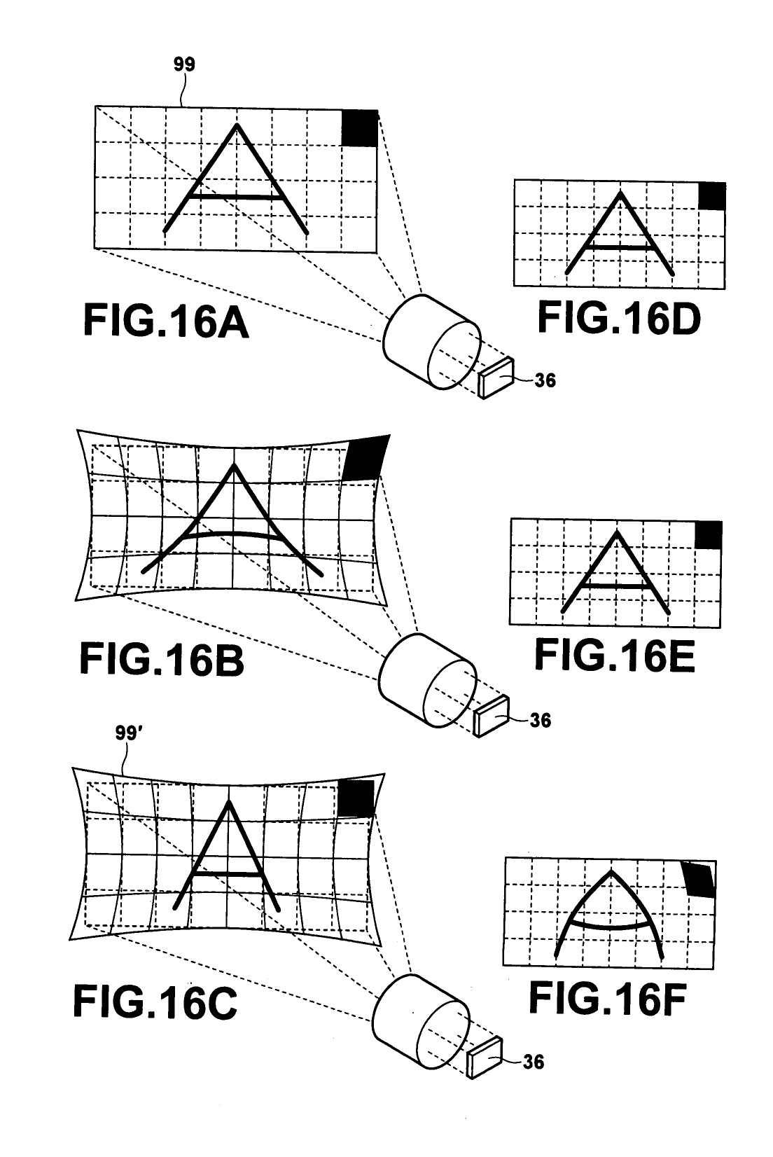

FIGS. 16A-16F illustrate an example of drawing distortion of one head, how it is corrected and how it influences the image.

As shown in FIG. 16A, in a case where no distortion is present in the optical system and the photosensitive material, the image data inputted to the DMD 36 is not particularly corrected as shown in FIG. 16D, and is directly outputted onto the photosensitive material 11 to draw an ideal image as shown in FIG. 16A.

However, in a case where drawing distortion is introduced in an image corresponding to one head due to factors such as temperature and/or vibration during exposure the emitted beams, the image 99 exposed by the exposure area 32 will deform as shown in FIG. 16B (if the image is inputted to the DMD 36 without correction), and therefore correction is necessary.

The image data to be inputted to the DMD 36 is corrected as shown in FIG. 16F. An amount of drawing distortion is found by the distortion amount calculating means based on the positional information of the image outputted onto the photosensitive material 11 measured by the beam position measuring means, and correction is appropriately carried out based on the detected amount of drawing distortion to finally obtain a correct image 99′ without distortion.

Next, operation of the exposing apparatus 10 having the above-described configuration will be explained.

Although not shown in the drawings, in the light source unit 16 which is a fiber array light source provided in the exposing apparatus 10, laser beams, such as ultraviolet rays, emitted from the laser light emitting devices in a form of divergent rays are collimated by a collimator lens and condensed by a condenser lens, and enter an input end of a core of a multimode optical fiber to propagate through the optical fiber. The beams are combined into a single laser beam at a laser output end and the combined beam is emitted from the optical fiber 28 coupled to the output end of the multimode optical fiber.

In this exposing apparatus 10, image data according to an exposure pattern is inputted to the controlling unit 20 connected to the DMD 36, and is temporarily stored in the memory in the controlling unit. The image data represents density values of pixels forming the image in binary values (i.e., whether or not a dot is recorded at the pixel). The image data is appropriately corrected by the control device based on the amount of drawing distortion (distortion condition) detected by the drawing distortion amount detecting means as described above.

The moving stage 14 holding the photosensitive material 11 on the surface thereof by applying suction is moved along the guides 30 from the upstream to the downstream in the conveyance direction at a constant speed by a driving device (not shown). As the moving stage 14 passes below the gate-shaped frame 22, the position detection sensors 24 fixed to the gate-shaped frame 22 detect the leading edge of the photosensitive material 11, and then the image data stored in the memory, which has been corrected based on the amount of drawing distortion detected by the drawing distortion amount detecting means, is sequentially read out for every multiple lines, and a control signal is generated for each exposure head 26 based on the read out image data at the control device serving as a data processing unit. It should be noted that the above-described correction based on the amount of drawing distortion (distortion condition) detected by the drawing distortion amount detecting means may be carried out when the control signal for each exposure head 26 is generated at the control device based on read-out image data which has not yet been corrected. Then, based on the generated control signal, each micromirror of the spatial light modulating element (DMD) 36 of each exposure head 26 is controlled on or off.

As the laser light is applied from the light source unit 16 to the spatial light modulating element (DMD) 36, the laser beams reflected by the “on”-state micromirrors of the DMD 36 are focused on appropriately corrected exposure positions for drawing. In this manner, the laser light emitted from the light source unit 16 is turned on or off for each pixel to expose the photosensitive material 11.

As the photosensitive material 11 moves together with the moving stage 14 at a constant speed, the photosensitive material 11 is scanned by the exposure head unit 18 in the direction opposite to the direction of movement of the stage, and the band-like exposed area 34 (shown in FIG. 2) for each exposure head 26 is formed on the photosensitive material 11.

When the scanning of the photosensitive material 11 by the exposure head unit 18 is completed and the position detection sensors 24 detect the trailing edge of the photosensitive material 11, the moving stage 14 is returned by the driving device (not shown) along the guides 30 to the point of origin at the most upstream side in the conveyance direction, and is again moved along the guides 30 from the upstream to the downstream in the conveyance direction at a constant speed.

Although the DMD is used as the spatial light modulating element for use in the exposure head 26 in the exposing apparatus 10 according to this embodiment, for example, MEMS (Micro Electro Mechanical Systems)-type spatial light modulating element (SLM: Special Light Modulator), or a spatial light modulating element other than MEMS-type spatial light modulating elements such as an optical element (PLZT device) that modulates light transmitting therethrough by an electro-optic effect or a liquid crystal optical shutter (FLC) may be used in stead of the DMD.

It should be noted that MEMS is a collective term referring to micro-systems, in which micro-sized sensors, actuators and control circuits are integrated, which are produced using micromachining technology based on IC production process. The MEMS-type spatial light modulating element refers to a spatial light modulating element driven by electromechanical operation using electrostatic force.

Further, in the exposing apparatus 10 according to this embodiment, the spatial light modulating element (DMD) 14 used in the exposure head 26 may be replaced with means for selectively turning on or off multiple pixels (means for selectively modulating multiple pixels). The means for selectively turning on or off multiple pixels may be formed, for example, by a laser light source that can selectively turn on or off laser beams corresponding to the pixels, or by a laser light source in which small laser emitting surfaces are arranged correspondingly to the pixels to form a surface emitting laser device, and the small laser emitting surfaces can be selectively turned on or off.

Furthermore, although the beam position is measured by detecting the beam passing through the detection slit 74 by the photosensor 72 in the exposing apparatus 10 according to this embodiment, the invention is not limited to this embodiment. For example, the beam position may be measured using a CCD or a four-section photodetector.

According to the method and apparatus for measuring a drawing position of the invention, a drawing position measuring method for measuring a position of a drawing point by a position measuring means disposed at the drawing surface when a drawing surface and a drawing point forming means for modulating incoming light and forming the drawing point on the drawing surface are moved relatively to each other and the drawing point forming means sequentially forms the drawing point on the drawing surface to draw an image during the relative movement is provided, in which a relative positional deviation between the drawing point forming means and the position measuring means is measured during the relative movement caused by the moving means, and the position of the drawing point measured by the position measuring means is corrected based on the measured positional deviation. Thus, even if a relative positional relationship between the position measuring means and the drawing point forming means is deviated by disturbance such as vibration, for example, the position of the drawing point can be corrected based on the positional deviation. This allows precise measurement of the position of the drawing point, thereby allowing drawing of a high precision image.

What is claimed is:

1. A drawing position measuring method for measuring a position of a drawing point by a position measuring means when a drawing surface and a drawing point forming means for modulating incoming light and forming the drawing point on the drawing surface are moved relatively to each other and the drawing point forming means sequentially forms the drawing point on the drawing surface to draw an image during the relative movement, the method comprising:
measuring a relative position between each drawing point formed by the drawing point forming means and the position measuring means during the relative movement; and
determining the position of the drawing point based on the measured relative position.

2. A drawing position measuring method for measuring a position of a drawing point by a position measuring means when a drawing surface and a drawing point forming means for modulating incoming light and forming the drawing point on the drawing surface are moved relatively to each other and the drawing point forming means sequentially forms the drawing point on the drawing surface to draw an image during the relative movement, the method comprising:
measuring a relative positional deviation between each drawing point formed by the drawing point forming means and the position measuring means during the relative movement; and
correcting the position of the drawing point measured by the position measuring means based on the measured positional deviation.

3. The method as claimed in claim 1, wherein
the position measuring means comprises at least two slits formed in substantially the same surface as the drawing surface, the at least two slits being not parallel to each other, and a detecting means for detecting the light modulated by the drawing point forming means and passing through the at least two slits, and
the position of the drawing point is measured based on each positional information of the relatively moved drawing surface corresponding to each time point of detection of the light passing through the at least two slits.

4. The method as claimed in claim 2, wherein
the position measuring means comprises at least two slits formed in substantially the same surface as the drawing surface, the at least two slits being not parallel to each other, and a detecting means for detecting the light modulated by the drawing point forming means and passing through the at least two slit, and
the position of the drawing point is measured based on each positional information of the relatively moved drawing surface corresponding to each time point of detection of the light passing through the at least two slits.

5. The method as claimed in claim 1, wherein
the position measuring means comprises at least three slits formed in substantially the same surface as the drawing surface, at least two of the slits being not parallel to each other, and a detecting means for detecting the light modulated by the drawing point forming means and passing through the at least three slits, and
the position of the drawing point is measured based on each positional information of the relatively moved drawing surface corresponding to each time point of detection of the light passing through the at least three slits.

6. The method as claimed in claim 2, wherein
the position measuring means comprises at least three slits formed in substantially the same surface as the drawing surface, at least two of the slits being not parallel to each other, and a detecting means for detecting the light modulated by the drawing point forming means and passing through the at least three slits, and
the position of the drawing point is measured based on each positional information of the relatively moved drawing surface corresponding to each time point of detection of the light passing through the at least three slits.

7. The method as claimed in claim 3 wherein the position measuring means comprises a plurality of position measuring means.

8. The method as claimed in claim 3 wherein the slits are formed in a glass plate.

9. The method as claimed in claim 8 wherein the slits are formed in a single glass plate.

10. An apparatus for measuring a drawing position, the apparatus comprising:
drawing point forming means for modulating incoming light and forming a drawing point on a drawing surface;
moving means for moving the drawing point forming means and the drawing surface relatively to each other;
position measuring means for measuring a position of the drawing point when the drawing point forming means sequentially forms the drawing point on the drawing surface to draw an image during the relative movement caused by the moving means;
relative position measuring means for measuring a relative position between each drawing point formed by the drawing point forming means and the position measuring means during the relative movement caused by the moving means; and
calculating means for determining the position of the drawing point based on the relative position measured by the relative position measuring means.

11. An apparatus for measuring a drawing position, the apparatus comprising:
drawing point forming means for modulating incoming light and forming a drawing point on a drawing surface;
moving means for moving the drawing point forming means and the drawing surface relatively to each other;
position measuring means for measuring a position of the drawing point when the drawing point forming means sequentially forms the drawing point on the drawing surface to draw an image during the relative movement caused by the moving means, the position measuring means being disposed at the drawing surface;
positional deviation measuring means for measuring a relative positional deviation between each drawing point formed by the drawing point forming means and the position measuring means during the relative movement caused by the moving means; and
correcting means for correcting the position of the drawing point measured by the position measuring means based on the positional deviation measured by the positional deviation measuring means.

12. The apparatus as claimed in claim 10, wherein
the position measuring means comprises at least two slits formed in substantially the same surface as the drawing surface, the at least two slits being not parallel to each other, and a detecting means for detecting the light modulated by the drawing point forming means and passing through the at least two slit, and
the position of the drawing point is measured based on each positional information of the relatively moved drawing surface corresponding to each time point of detection of the light passing through the at least two slits.

13. The apparatus as claimed in claim 11, wherein
the position measuring means comprises at least two slits formed in substantially the same surface as the drawing surface, the at least two slits being not parallel to each other, and a detecting means for detecting the light modulated by the drawing point forming means and passing through the at least two slit, and
the position of the drawing point is measured based on each positional information of the relatively moved drawing surface corresponding to each time point of detection of the light passing through the at least two slits.

14. The apparatus as claimed in claim 10, wherein
the position measuring means comprises at least three slits formed in substantially the same surface as the drawing surface, at least two of the slits being not parallel to each other, and a detecting means for detecting the light modulated by the drawing point forming means and passing through the at least three slits, and
the position of the drawing point is measured based on each positional information of the relatively moved drawing surface corresponding to each time point of detection of the light passing through the at least three slits.

15. The apparatus as claimed in claim 11, wherein
the position measuring means comprises at least three slits formed in substantially the same surface as the drawing surface, at least two of the slits being not parallel to each other, and a detecting means for detecting the light modulated by the drawing point forming means and passing through the at least three slits, and
the position of the drawing point is measured based on each positional information of the relatively moved drawing surface corresponding to each time point of detection of the light passing through the at least three slits.

16. The apparatus as claimed in claim 12, wherein the position measuring means comprises a plurality of position measuring means.

17. The apparatus as claimed in claim 12, wherein the slits are formed in a glass plate.

18. The apparatus as claimed in claim 17, wherein the slits are formed in a single glass plate.
